(19) United States
(12) Patent Application Publication
(10) Pub. No.: US 2014/0225559 A1
(43) Pub. Date: Aug. 14, 2014

(54) MOTOR-DRIVEN TRAVELLING BODY AND HIGH-SPEED CHARGE METHOD FOR MOTOR-DRIVEN TRAVELLING BODY

(71) Applicant: INSTITUTE FOR ENERGY APPLICATION TECHNOLOGIES CO., LTD., Kawasaki-shi (JP)

(72) Inventor: Tomio SUGANO, Tochigi (JP)

(73) Assignee: INSTITUTE FOR ENERGY APPLICATION TECHNOLOGIES CO., LTD., Kawasaki-shi (JP)

(21) Appl. No.: 14/256,801

(22) Filed: Apr. 18, 2014

Related U.S. Application Data
(63) Continuation of application No. 12/595,466, filed on Oct. 9, 2009.

(30) Foreign Application Priority Data
Apr. 17, 2007 (JP) 2007-108412

(51) Int. Cl. B60L 11/18

(52) U.S. Cl. CPC B60L 11/1809; B60L 11/182; B60L 11/1816
USPC 320/108; 320/109; 320/166; 320/167

(57) ABSTRACT

An electrically-driven mobile body which can be given a boosting charge with electric power supplied by a single power supply apparatus together with other electrically-driven mobile bodies having different charging conditions and which can cool a charging system thereof without any coolant from the outside, as well as a boosting charge method for an electrically-driven mobile body for the same purpose.

An electrically-driven mobile body (50) which includes a power storing means (85) storing DC power supplied by an external power supply apparatus (10) and is driven with DC power stored in the power storing means (85), includes: a charge controlling means (80) for controlling DC power supplied by the power supply apparatus (10) in such a way that the DC power has a voltage and an electric current suitable for giving the power storing means (85) a boosting charge; and a cooling means (60) for cooling a charging system of the power storing means (85) forcedly with DC power supplied by the power supply apparatus (10).

### TECHNICAL FIELD

The present invention relates to an electrically-driven mobile body such as a vehicle and a ship having an electric motor as the prime mover thereof, and particularly, it relates to an electrically-driven mobile body given a boosting charge with electric power supplied by an external power supply apparatus and a boosting charge method for an electrically-driven mobile body for the same purpose.

An electric vehicle, emitting no exhaust gas and environment-friendly, has the problem of taking a relatively long time to charge. In order to shorten the charge time, the electric vehicle has to be given a great amount of electric power in a short time, thereby requiring power equipment having a larger power capacity in a location where only a low-voltage power line is laid. Hence, an electric vehicle is generally given a boosting charge by rectifying commercial AC power, storing DC power in a storage battery and utilizing the stored DC power (refer to Patent Documents 1 and 2). Patent Document 1 offers a charging apparatus including only one charger, the charger being switched using a change-over switch and thereby charging both a storage battery for equipment and a storage battery for an electric vehicle. Patent Document 2 offers a charging apparatus including a daytime storage battery storing electric power in the daytime and a nighttime storage battery storing electric power in the nighttime, in which residual electric power in the nighttime storage battery can be supplied via a charger to a storage battery for an electric vehicle during the daytime.

When an electric vehicle is given a boosting charge with a large amount of electric current, a charging system thereof generates heat and needs cooling forcedly. Therefore, an electrically-driven mobile body (refer to Patent Document 3) is known which is capable of cooling a charging system thereof in a boosting charge by supplying cold air for cooling a storage battery thereof from the outside to thereby prevent the temperature of the storage battery from becoming excessive high.

### Patent Document 1: Japanese Patent Laid-Open Publication No. 5-207668

### Patent Document 2: Japanese Patent Publication No. 3334115

### Patent Document 3: Japanese Patent Laid-Open Publication No. 8-37705

### DISCLOSURE OF THE INVENTION

### Problems to be Solved by the Invention

However, the charging apparatuses according to Patent Documents 1 and 2 have charging conditions set based on the specification of a storage battery mounted on an electric vehicle and cannot charge a plurality of vehicles having different charging conditions, thereby restricting vehicle types to be charged and requiring a plurality of charging apparatuses capable of charging a plurality of vehicles having various charging conditions at the same time. The electrically-driven mobile body according to Patent Document 3 is supplied from the outside with a coolant for cooling the storage battery in a boosting charge, thereby complicating the charging work and the apparatus configuration.

When electric vehicles have a boosting-charge control function suitable for a storage battery thereof, even if they have charging conditions different from each other, then a single power supply apparatus can supply electric power and give a boosting charge to the variety of electric vehicles at the same time, thereby spreading electric vehicles more widely. In addition, if a heat-generation part in a charging system is cooled at a boosting charge without any coolant from the outside, the boosting-charge work becomes easier and the apparatus configuration simpler. Nowadays, improving the global environment has become a pressing task, thereby seeking for electrical drive in the sectors of vehicles, as well as other mobile bodies emitting exhaust gases including shipping and aircraft.

Therefore, it is an object of the present invention to provide an electrically-driven mobile body which can be given a boosting charge with electric power supplied by a single power supply apparatus simultaneously with other electrically-driven mobile bodies having different charging conditions and which can cool a charging system thereof without any coolant from the outside, as well as a boosting charge method for an electrically-driven mobile body for the same purpose.

Means for Solving the Problems

In order to accomplish the object, an electrically-driven mobile body according to claim 1 which includes a power storing means storing electric power supplied by an external power supply apparatus and is driven with electric power stored in the power storing means, includes: a charge controlling means for controlling electric power supplied by the power supply apparatus in such a way that the electric power has a voltage and an electric current suitable for giving the power storing means a boosting charge; and a cooling means for cooling a charging system of the power storing means forcedly with electric power supplied by the power supply apparatus.

According to claim 2, in the electrically-driven mobile body according to claim 1, the cooling means includes an electronic cooling element operating with electric power from the power supply apparatus.

According to claim 3, in the electrically-driven mobile body according to claim 1, the charge controlling means includes a charge control unit having a DC chopper circuit for regulating electric power supplied by the power supply apparatus in such a way that the electric power has a voltage suitable for giving a boosting charge to the power storing means.

According to claim 4, in the electrically-driven mobile body according to claim 1, the power storing means is formed by at least one of a storage battery, an electric double-layer capacitor and a lithium-ion capacitor.

According to claim 5, in the electrically-driven mobile body according to claim 1, the power storing means is formed by a lithium-ion battery.

According to claim 6, in the electrically-driven mobile body according to claim 1, the charge controlling means is provided with a charge-completion alarming means notifying a portable receiver of the driver that a charge given to the power storing means is completed.

A boosting charge method for an electrically-driven mobile body according to claim 7 which stores electric power supplied by an external power supply apparatus in a power storing means provided therein and is driven with electric power stored in the power storing means, includes the steps of: controlling electric power supplied by the external power supply apparatus in such a way that the electric power has a voltage and an electric current suitable for giving the power storing means a boosting charge; and cooling a charging system of the power storing means forcedly with electric power supplied by the power supply apparatus.

According to claim 8, in the boosting charge method for an electrically-driven mobile body according to claim 7, the electrically-driven mobile body is supplied with pure DC power from an electric-power storing means in the power supply apparatus.

According to claim 9, in the boosting charge method for an electrically-driven mobile body according to claim 7, the electrically-driven mobile body is supplied with electric power from the power supply apparatus by either a conductive charging method or an inductive charging method.

According to claim 10 is characterized in that, in the boosting charge method for an electrically-driven mobile body according to claim 7, the electrically-driven mobile body is supplied with electric power generated using renewable energy.

### Advantages of the Invention

The electrically-driven mobile body according to claim 1 and the boosting charge method for an electrically-driven mobile body according to claim 7 are capable of controlling electric power supplied by the power supply apparatus in such a way that the electric power has a voltage and an electric current suitable forgiving the power storing means a boosting charge. This make it possible to give an electrically-driven mobile body having different charging conditions a boosting charge with electric power supplied by the same power supply apparatus. The charge control is extremely significant because it may affect the life or the like of the power storing means. In designing an electrically-driven mobile body having a charge control function fitted for the power storing means, the charge control can be determined by fully studying characteristics of the power storing means. Conventionally, a boosting-charge apparatus and an electrically-driven mobile body such as a vehicle are each produced by a separate manufacturer, but an electrically-driven mobile body is provided with a charge control function, thereby enabling the mobile-body manufacturer to design the power storing means and the charge control together. This makes it possible to design the power storing means in such a way that it has a higher performance, thereby enhancing the mobility (e.g., potential traveling distance) of the electrically-driven mobile body. Besides, the cooling means cools a heat-generation part of the charging system with electric power supplied by the power supply apparatus, thereby saving supplying a coolant from the outside, so that the charging work becomes easier and the apparatus configuration simpler.

According to claim 2, the electronic cooling element operating with electric power from the power supply apparatus cools a heat-generation part of the charging system, thereby saving a coolant such as chlorofluoro carbon and hence contributing toward improving the global environment.

According to claim 3, the charge controlling means includes a charge control unit having a DC chopper circuit, and thereby, even if the charging voltage for the power storing means differs from the output voltage of electric power supplied by the power supply apparatus, it can be regulated to an optimum voltage for giving a boosting charge to the power storing means.

According to claims 4 and 5, the power storing means has a higher energy density and stores a greater amount of electric power, thereby lengthening the traveling distance of the electrically-driven mobile body for one boosting charge.

According to claim 6, the charge-completion alarming means notifies a portable receiver of the driver that the power storing means has been charged, thereby permitting the driver to stay away from the electrically-driven mobile body while being charged and spend the charging time effectively.

According to claim 8, the electrically-driven mobile body can be supplied with high-quality electric power equivalent to pure DC power, thereby almost saving considering a noise, a surge or the like in designing electric circuits of the electrically-driven mobile body, so that the electric circuits of the electrically-driven mobile body can be more easily designed.

According to claim 9, the electrically-driven mobile body is supplied with electric power from the power supply apparatus with the conductors thereof being in contact in a conductive charging method as well as with the conductors being out of contact using electro-magnetic induction in an inductive charging method, thereby facilitating the charging work.

According to claim 10, the electrically-driven mobile body is supplied with electric power generated using renewable energy, thereby generating electric power without emitting carbon dioxide and hence contributing toward improving the global environment.

### BRIEF DESCRIPTION OF THE DRAWINGS

FIG. 1 is an electric circuit diagram showing the connection of an electrically-driven mobile body and a power supply apparatus according to a first embodiment of the present invention.

FIG. 2 is an electric circuit diagram of a charge controlling means in the electrically-driven mobile body of FIG. 1.

FIG. 3 is a schematic block diagram showing a cooling unit in the electrically-driven mobile body of FIG. 1.

FIG. 4 is a schematic block diagram showing the power supply apparatus simultaneously charging electrically-driven mobile bodies as shown in FIG. 1.

FIG. 5 is a front view of a charging stand and vicinities thereof in the power supply apparatus of FIG. 4.

FIG. 6 is an electric circuit diagram of a switching means in the power supply apparatus of FIG. 4.

FIG. 7 is a flow chart showing a control procedure of a power-supply controlling means in the power supply apparatus of FIG. 4.

FIG. 8 is a flow chart showing a charging procedure in the power supply apparatus of FIG. 4.

FIG. 9 is a flow chart showing the charging procedure in the power supply apparatus of FIG. 4, continuing from FIG. 8.

FIG. 10 is a schematic block diagram showing a boosting charge for electrically-driven mobile bodies according to a second embodiment of the present invention.

FIG. 11 is a schematic block diagram showing a boosting charge for electrically-driven mobile bodies according to a third embodiment of the present invention.

FIG. 12 is a front view of a charging stand giving a boosting charge to an electrically-driven mobile body and vicinities thereof according to a fourth embodiment of the present invention.

FIG. 13 is a schematic block diagram showing a boosting charge for electrically-driven mobile bodies with electric power generated using renewable energy according to a fifth embodiment of the present invention.

### DESCRIPTION OF THE SYMBOLS

5 wind power generator
6 solar-photovoltaic power generator
7 electric-power regulator
10 power supply apparatus
15 first power storing means (electric-power storing means)
20 charging circuit
21 charging stand
30 switching means
31 switch
32 switching control section
36 charging plug
50 vehicle (electrically-driven mobile body)
60 cooling means
61 electronic cooling element
65 charging connector
75 charge-completion alarming means
80 charge controlling means
81 power control section
82 charge control unit
83 temperature control unit
84 charge-information processing section
85 second power storing means (power storing means)
89 portable receiver
95 primary winding
96 secondary winding
100 ship (electrically-driven mobile body)
110 aircraft (electrically-driven mobile body)

### BEST MODE FOR CARRYING OUT THE INVENTION

Next, embodiments of the present invention will be described in detail with reference to the drawings.

### FIRST EMBODIMENT

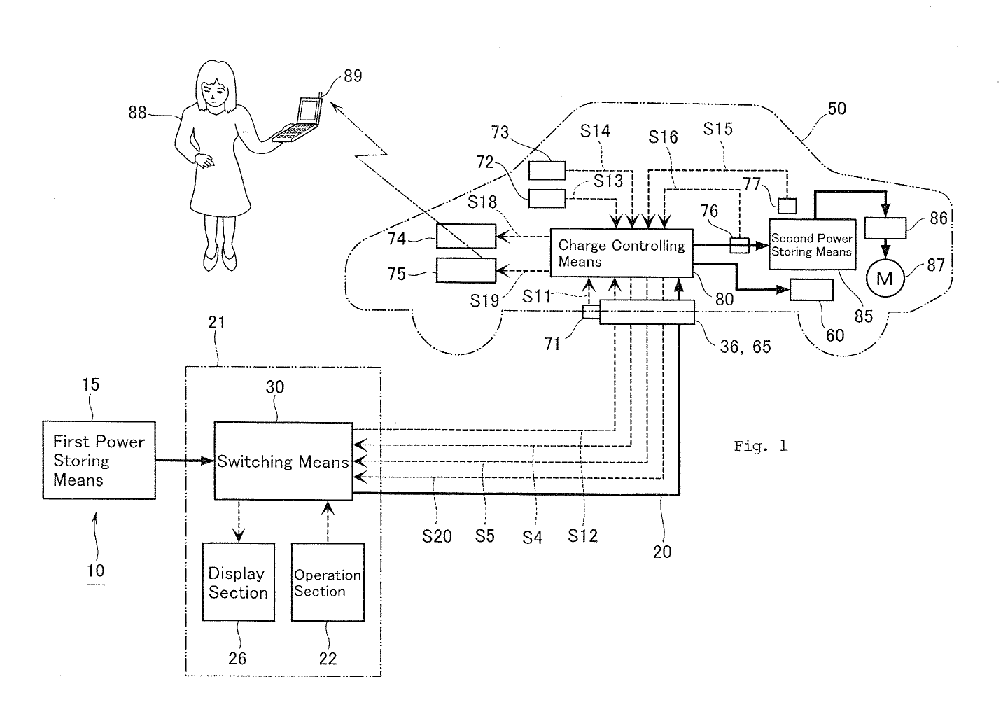

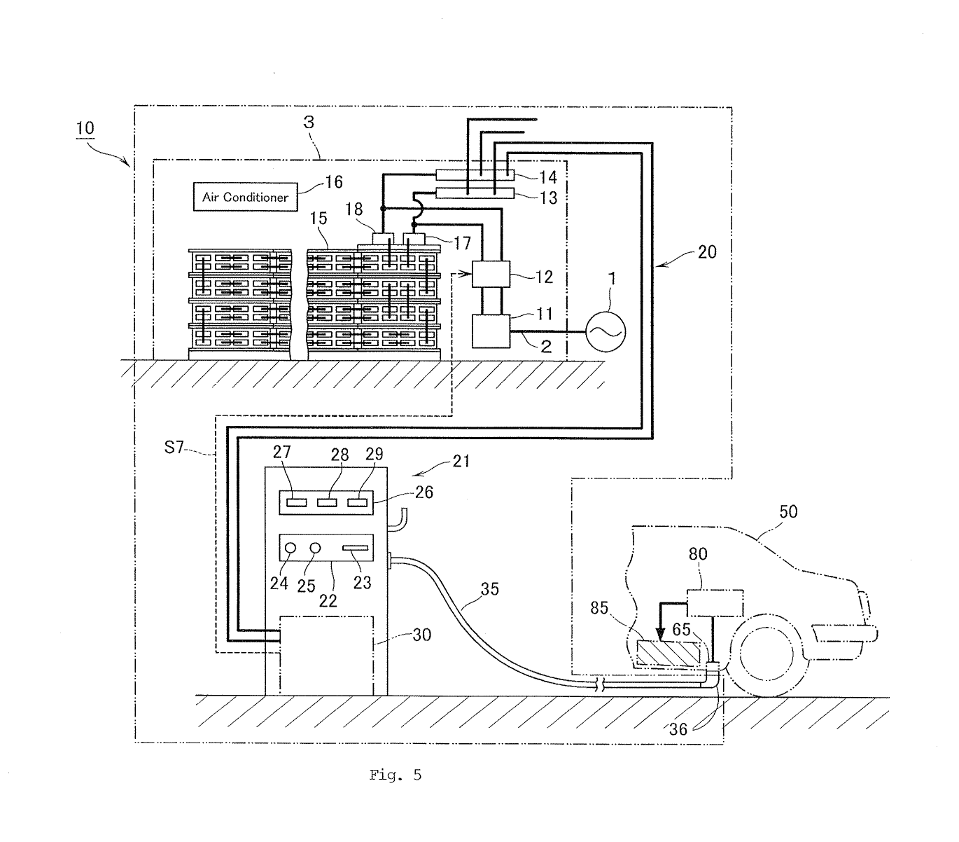

FIGS. 1 to 9 show a first embodiment of the present invention. In FIG. 5, reference numeral 1 denotes a commercial AC power source such as a three-phase AC power source which supplies electric power through a power line 2 into a construction 3. The construction 3 houses: a rectifier 11 as a power supplying means constituting a power supply apparatus 10; a power-supply controlling means 12; a first power storing means 15; and other equipment. The rectifier 11 is connected on the input side to the power line 2 inside of the construction 3 and-has the function of converting three-phase AC power from the power line 2 into DC power after regulating it to a predetermined voltage. On the output side, the rectifier 11 is connected via the power-supply controlling means 12 to the first power storing means 15. As described later, the power-supply controlling means 12 has the function of stopping the rectifier 11 from supplying DC power to the first power storing means 15 based on a signal S7 from a switching means 30.

The first power storing means 15 as an electric-power storing means having the function of storing DC power from the rectifier 11 may be any type as long as it can store DC power and in this embodiment, it is formed by at least one of a storage battery, an electric double-layer capacitor and a lithium-ion capacitor. The first power storing means 15 may be formed, for example, by only a valve-regulated lead-acid battery having many cells connected in series, both a storage battery and a double-layer capacitor, or a large-capacity electric double-layer capacitor alone. Further, the storage battery may be formed by a large-capacity lithium-ion battery, though it is expensive. Herein, a lithium-ion capacitor is a power storing means having both elements of a lithium-ion battery and an electric double-layer capacitor. The rectifier 11 has the function of charging the first power storing means 15 in consideration of charging characteristics thereof. It is desirable that the first power storing means 15 has a total voltage which approximates the total voltage of a second power storing means 85 of a vehicle 50 (described later). In this embodiment, the total voltage of the first power storing means 15 is, for example, approximately DC 350 volts, but it is variable by changing the number of cells.

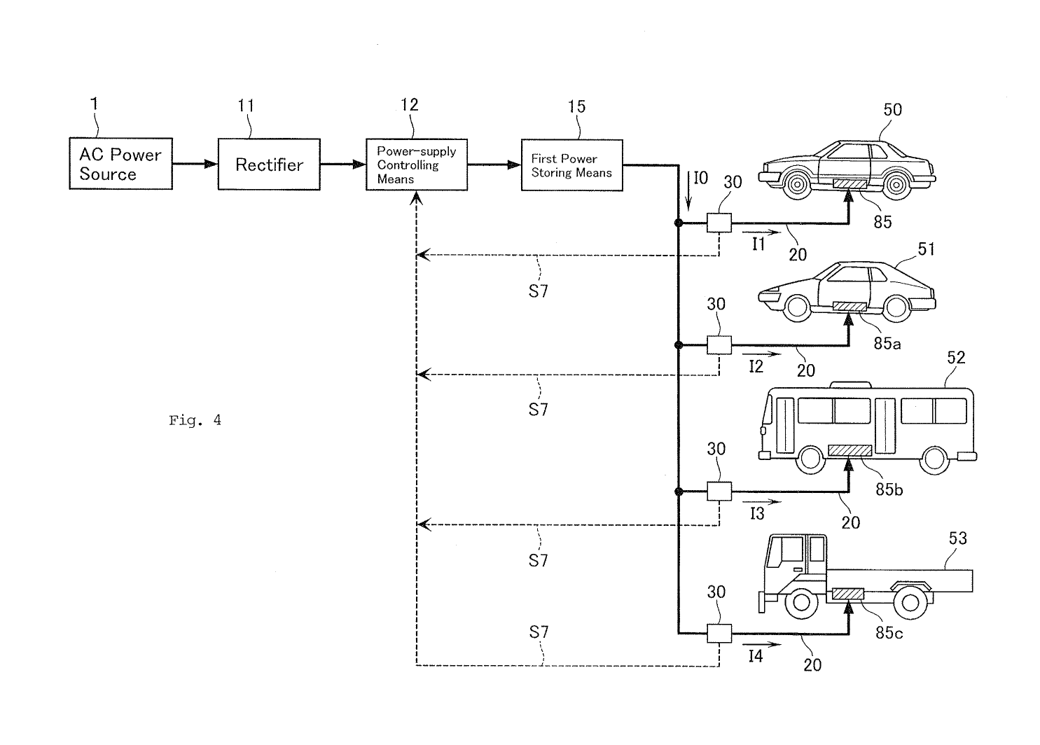

As shown in FIG. 5, the first power storing means 15 includes a positive terminal block 17 and a negative terminal block 18 connected via the power-supply controlling means 12 to the output side of the rectifier 11. The construction 3 houses a positive common terminal block 13 and a negative common terminal block 14 forming a part of a charging circuit 20. The positive common terminal block 13 and negative common terminal block 14 are used for supplying DC power from the first power storing means 15 to a plurality of charging stands 21 outside of the construction 3 and are connected through the charging circuit 20 to the switching means 30 of the charging stand 21. The charging circuit 20 is an electric circuit for supplying pure DC power from the first power storing means 15 up to a vehicle 50 (described later). As shown in FIG. 4, since a plurality of vehicles are simultaneously charged in this embodiment, a plurality of charging circuits 20 are connected in parallel to the positive common terminal block 13 and negative common terminal block 14. In the construction 3, an air conditioner 16 keeping the room temperature substantially constant is installed, thereby lengthening the life of the first power storing means 15.

In FIG. 5, the charging stand 21 lies in a charging station near the construction 3 and a plurality of the charging stands 21 are supplied through each charging circuit 20 with DC power from the first power storing means 15. The charging stand 21 is provided on a side thereof with: an operation section 22 including a charge card reader 23, a charge starting switch 24 and a charge forcedly-stopping switch 25; and a display section 26 including a charge power-amount indicator 27, a charging current indicator 28 and a charge power-rate indicator 29. The switching means 30 housed in the charging stand 21 is connected to a charging cable 35 forming a part of the charging circuit 20. The charging cable 35 is held on a side of the charging stand 21 when not used for charge while it extends to the vehicle 50 as an electrically-driven mobile body when used for charge. The charging cable 35 is provided at the front end with a charging plug 36 to be connected to a charging connector 65 of the vehicle 50.

FIG. 1 shows the connection of the charging stand 21 and the vehicle 50 as an electrically-driven mobile body at the time of charging. The charging plug 36 of the charging cable 35 is connected to the charging connector 65 of the vehicle 50 and thereby the first power storing means 15 supplies pure DC power to the vehicle 50 via the switching means 30 in the middle of the charging circuit 20. The switching means 30 has the function of making a switching motion based upon a signal from the operation section 22 of the charging stand 21 or a signal from the vehicle 50 and thereby allowing the first power storing means 15 to supply or stop supplying pure DC power to the vehicle 50. Through the charging circuit 20, therefore, the switching means 30 supplies the pure DC power to the vehicle 50.

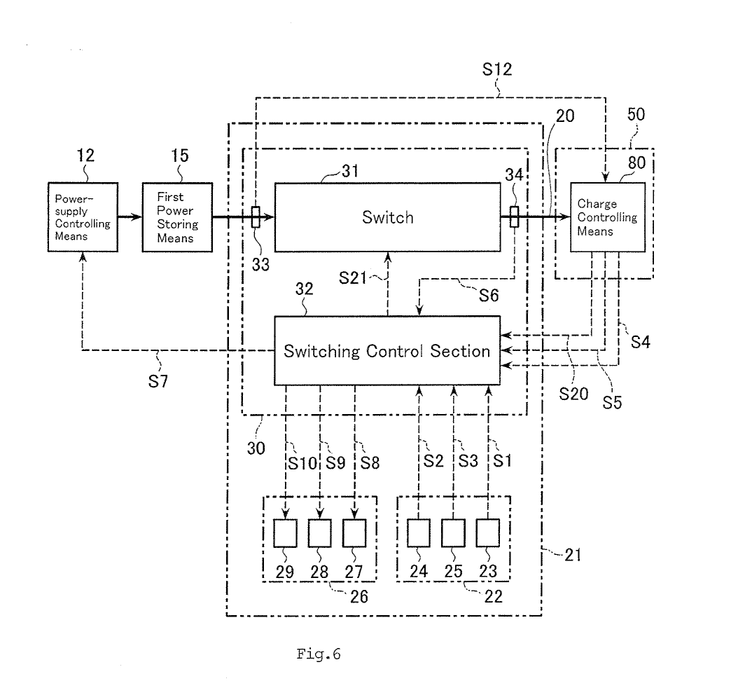

FIG. 6 shows in detail the switching means 30 including a switch 31 and a switching control section 32. The switch 31 has the switching function of supplying or stopping pure DC power supplied from the first power storing means 15 and is formed by a semiconductor device and an electro-magnetic contactor. The switch 31 making a switching motion based on a signal S21 from the switching control section 32 and is provided on the output side with an electronic-power sensor 34 detecting a voltage and an electric current of DC power on the output side of the switch 31. In the switching control section 32, a signal S6 from the electronic-power sensor 34 is inputted; a signal S1 from the charge card reader 23, a signal S2 from the charge starting switch 24 and a signal S3 from the charge forcedly-stopping switch 25 can be inputted; and further, signals S4, S5 and S20 from a charge controlling means 80 of the vehicle 50 can be inputted. The switching control section 3 has the function of outputting a power-supply stop signal S7 to the power-supply controlling means 12 if necessary in response to each inputted signal. Specifically, if deciding based on an inputted signal that the vehicle 50 is being charged, the switching control section 3 outputs the power-supply stop signal S7 to the power-supply controlling means 12 to thereby stop the first power storing means 15 from supplying DC power. The switching control section 32 outputs signals S8, S9 and S10 to the display section 26 of the charging stand 21. The signal S8 is for indicating a power amount (power supply) from the start of a charge in the charge power-amount indicator 27; S9, indicating a charging current flowing from the switch 31 to the vehicle 50 in the charging current indicator 28; S10, indicating a power rate equivalent to a power amount supplied to the vehicle 50 from the start to the end of a charge in the charge power-rate indicator 29. The switch 31 is provided for convenience, and hence, without the switch 31, the vehicle 50 could be given a boosting charge using the charging circuit 20.

As shown in FIG. 1, the vehicle 50 houses the charge controlling means 80 as well as various apparatuses. The vehicle 50 is supplied with pure DC power, and the charge controlling means 80 controls it to predetermined voltage and current and supplies it to a second power storing means 85. As the second power storing means 85, any type may be used so long as it can store DC power, but in this embodiment, it is formed by at least any one of a storage battery, an electric double-layer capacitor and a lithium-ion capacitor. The second power storing means 85 may be formed, for example, by only a lithium-ion battery having many cells connected in series, or it may be formed by both a lithium-ion battery and a double-layer capacitor or a lithium-ion capacitor. As described earlier, a lithium-ion capacitor is a power storing means having both elements of a lithium-ion battery and an electric double-layer capacitor.

In this embodiment, the second power storing means 85 has a total voltage of approximately DC 350 volts which approximates the total voltage of the first power storing means 15. Since the charge controlling means 80 has a charge control function most suitable for giving a boosting charge to the second power storing means 85, the second power storing means 85 is given a boosting charge without any difficulty even though the total voltage of the second power storing means 85 differs significantly from that of the first power storing means 15. During the boosting charge, the first power storing means 15 supplies electric power to the second power storing means 85 of the vehicle 50, thereby reducing the residual capacity gradually and dropping the total voltage thereof. However, even if the total voltage of the first power storing means 15 goes down, the charge controlling means 80 enables a boosting charge at an optimum charging voltage for the second power storing means 85. The DC power stored in the second power storing means 85 is supplied via a controller 86 to a running motor 87, so that the vehicle 50 makes a run using the running motor 87 as a drive source. The vehicle 50 is provided with a cooling means 60 cooling a heat-generation part in the charging system thereof.

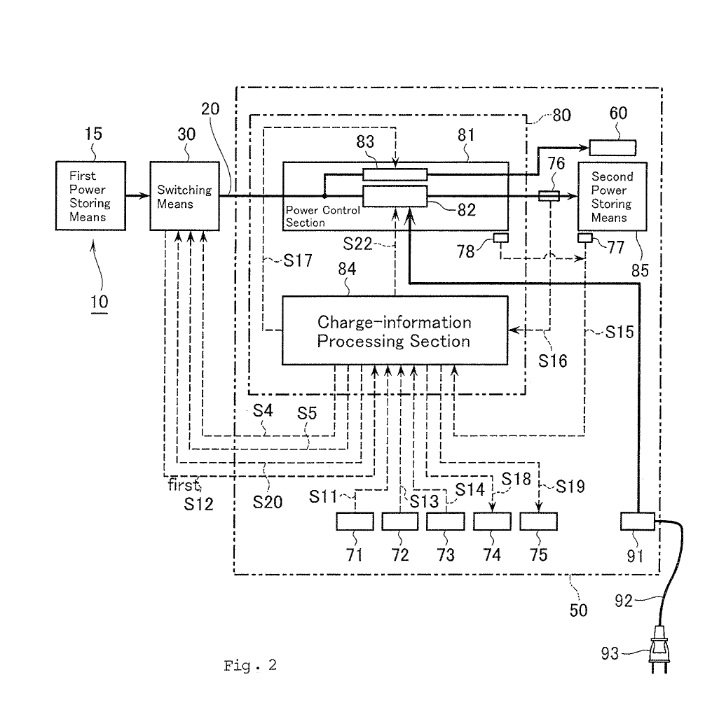

FIG. 2 shows in detail the charge controlling means 80 including a power control section 81 and a charge-information processing section 84. The power control section 81 is formed by a charge control unit 82 and a temperature control unit 83. The charge control unit 82 has the boosting-charge control function of controlling pure DC power from the switching means 30 to a charging voltage and a charging current suitable for the second power storing means 85. The charge control unit 82 includes a DC chopper circuit (having both a step-up chopper circuit and a step-down chopper circuit) and a current control circuit. On the basis of a control signal S22 from the charge-information processing section 84, the charge control unit 82 gives chopper control to pure DC power supplied from the first power storing means 15 to thereby charge the second power storing means 85 at an optimum charging voltage. An output sensor 76 measures a voltage and an electric current outputted from the charge control unit 82 to the first power storing means 15 and outputs a signal S16 to the charge-information processing section 84. Charging a lithium-ion battery requires precise control especially of the charging voltage, and taking this into account, the charge controlling means 80 controls the charge with a high precision. The charge control unit 82 including the DC chopper circuit having both the step-up chopper circuit and the step-down chopper circuit allows the DC chopper circuit to control the voltage from the first power storing means 15 even if the total voltage of the first power storing means 15 gradually drops in charging the vehicle 50 and thereby charges the second power storing means 85 at an optimum charging voltage. Therefore, variations in the output voltage of the first power storing means 15 in a boosting charge cannot affect a charge for the second power storing means 85. Hence, the charge-information processing section 84 has a charge program inputted beforehand for giving optimum charge control to the second power storing means 85 based upon the detected battery voltage and charging current of the second power storing means 85.

As shown in FIG. 2, the vehicle 50 includes a converter 91 converting AC power into DC power. The converter 91 connects on the input side with a cable 92 and a charging plug 93 provided at the front end thereof and on the output side with the charge control unit 82. The charging plug 93 is connected to, for example, a plug socket for domestic (home-use) 100 or 200 volts to charge the vehicle 50 using a domestic AC-power source, and in the nighttime, the vehicle 50 is supplied with electric power via the charging plug 93. After the converter 91 converts AC power from a domestic 100-volt socket into DC power, the charge control unit 82 regulates the electric power in such a way that it has a voltage and an electric current suitable for charging conditions of the second power storing means 85. Therefore, the vehicle 50 is designed to be given a boosting charge at a charging station and a long nighttime charge at home.

As shown in FIG. 2, many signals are inputted in and outputted from the charge-information processing section 8 of the charge controlling means 80. The switch 31 of FIG. 6 is provided on the input side with a voltage measurement sensor 33 having the function of measuring an output voltage of the first power storing means 15. Upon starting a charge, the voltage measurement sensor 33 inputs a signal S12 in the charge-information processing section 84. If the output voltage (open-circuit voltage) of the first power storing means 15 is within a predetermined range, then the charge-information processing section 84 outputs, to the switching control section 32 of the switching means 30, a signal S5 that the vehicle 50 can be given a boosting charge.

As shown in FIG. 1, the vehicle 50 includes a lock sensor 71, a driving-start checking sensor 72, a parking-brake sensor 73, a charge power-amount indicator 74 and a charge-completion alarming means 75. The lock sensor 71 detects the charging plug 36 being connected to the charging connector 65 of the vehicle 50, and before a charge starts, inputs a signal S11 in the charge-information processing section 84. The driving-start checking sensor 72 detects the vehicle 50 starting, and before the charge starts, inputs a signal S13 in the charge-information processing section 84. The parking-brake sensor 73 detects the parking brake working to thereby prevent the vehicle 50 from moving, and before the charge starts, inputs a signal S14 in the charge-information processing section 84. The charge power-amount indicator 74 indicates a residual power amount of the second power storing means 85, and during the charge, is given a signal S18 by the charge-information processing section 84.

The charge-completion alarming means 75 has the function of notifying a driver 88 that the second power storing means 85 has been fully charged. The current sensor 76 measures a charging current sent to the second power storing means 85 while a charge is given, and on the basis of the signal S16 from the current sensor 76, the charge-information processing section 84 decides whether the second power storing means 85 has been fully charged. Upon deciding that the second power storing means 85 has been fully charged, the charge-information processing section 84 outputs a signal S19 to the charge-completion alarming means 75. The charge control unit 82 including the DC chopper circuit notifies a portable receiver (including a cellular phone) 89 possessed by the driver 88 by radio that it has been fully charged. If an abnormality in the charging function of the vehicle 50 is detected during the charge, the charge-information processing section 84 outputs the signal S20 to the switching control section 32 of the switching means 30 to allow the switch 31 to make a cut-off motion, thereby stopping charging the vehicle 50.

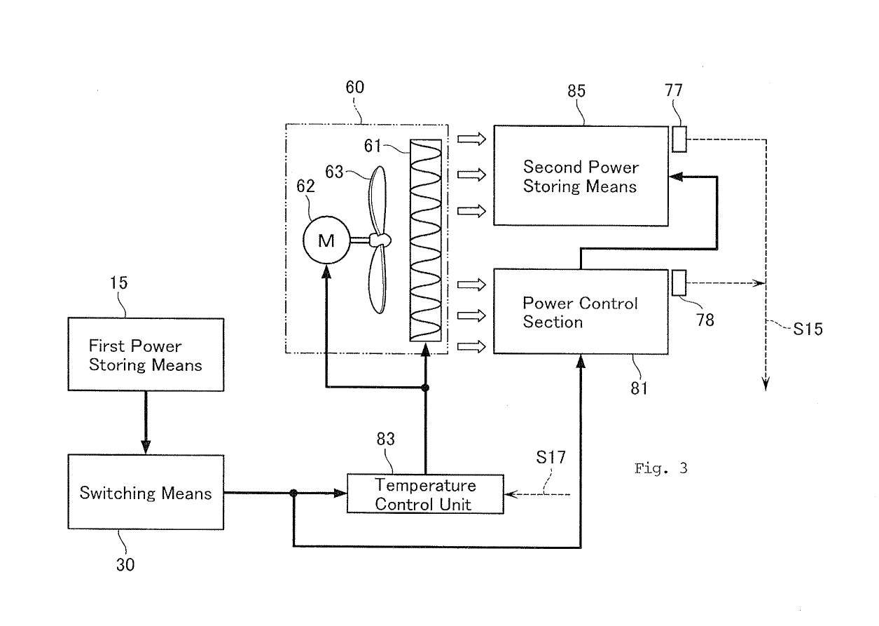

FIG. 3 shows a configuration of the cooling means 60 cooling a charging system of the vehicle 50. The cooling means 60 includes an electronic cooling element 61, a motor 62 and a fan 63. The fan 63 is rotated by the motor 62 and thereby blows air to the cooling surface of the electronic cooling element 61. The electronic cooling element 61 works using the Peltier effect and operates with DC power from the first power storing means 15. The charging system of the vehicle 50 is provided at easily heat-generating parts with a first temperature sensor 77 detecting a temperature of the second power storing means 85 and a second temperature sensor 78 detecting a temperature of the power control section 81. A signal S15 from the first temperature sensor 77 and the second temperature sensor 78 is inputted in the charge-information processing section 84. If the temperature of a specified place in the charging system of the vehicle 50 exceeds a predetermined value, the charge-information processing section 84 outputs a signal S17 to the temperature control unit 83, and on the basis of the signal S17, the temperature control unit 83 supplies the cooling means 60 with DC power from the switching means 30. FIG. 3 shows the cooling means 60 cooling only the power control section 81 and the second power storing means 85, but the cooling means 60 also cools a heat-generation part at a boosting charge with a large amount of electric current.

At the time of a boosting charge, the power control section 81 controls a great amount of electric power supplied from the first power storing means 15 and thereby the temperature of a semiconductor device thereof may rise. Further, the second power storing means 85 houses a lithium-ion battery thereof densely in a housing space and thereby the temperature of the lithium-ion battery may rise at the boosting-charge time. In the power control section 81 and the second power storing means 85, therefore, if the temperature rises beyond the predetermined value through the boosting charge, they are cooled forcedly with air blown by the cooling means 60. In order to enhance the capability to cool the semiconductor device of the power control section 81 where the temperature can rise sharply, especially, the electronic cooling element 61 may be attached directly to the power control section 81. Alternatively, it may be appreciated that the electronic cooling element 61 cools water circulating through the charging system to cool a heat-generation part with the cooled water. Instead of the cooling structure using the electronic cooling element 61 in this implementation, for example, a cooling structure allowing a motor fan to cool cooling water passing through a radiator such as forced cooling for an internal combustion engine may be employed as the cooling means 60, as long as electric power supplied from the first power storing means 15 is utilized. Alternatively, a heat-generation part of the charging system may be provided with a heat-electrical power generation device (not shown) to thereby supply the vehicle 50 for good use with electric power generated by the heat-electrical power generation device.

The power supply apparatus 10 according to the present invention is capable of charging a vehicle having a motor as the prime mover thereof, including the vehicle 50 such as a passenger car of FIG. 4, and a sports car 51, a bus 52 and a truck 53. Further, the boosting-charge vehicle includes a transportation vehicle, a railroad car, a streetcar, a monorail car, a construction vehicle and the like. According to vehicle types, the cell number, capacity or the like of the second power storing means is different, and thereby, the sports car 51, the bus 52 and the truck 53 include second power storing means 85a, 85b and 85c, respectively, which are different from that of the vehicle 50. The sports car 51, the bus 52 and the truck 53 each have a charge control function suitable for the second power storing means 85a, 85b and 85c, respectively.

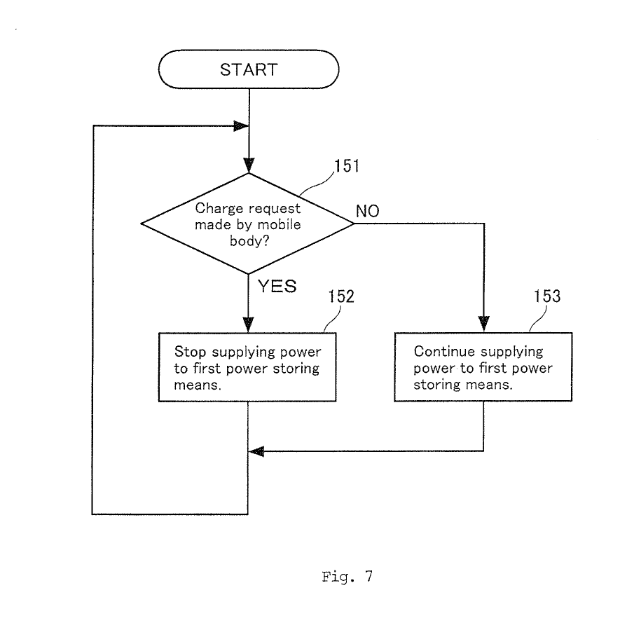

Next, a description will be given about a boosting charge method for an electrically-driven mobile body according to the first embodiment. FIG. 7 shows a control procedure of the power-supply controlling means 12 in which a decision is made whether the vehicle 50 as an electrically-driven mobile body has made a charge request in a step 151, and if the decision is made that the vehicle 50 has made a charge request in the step 151, then the processing goes to a step 152, the switching means 30 outputs the signal S7 to the power-supply controlling means 12 and the rectifier 11 stops supplying DC power to the first power storing means 15. On the other hand, if the decision is made that the vehicle 50 has made no charge request in the step 151, then the processing goes to a step 153 and the rectifier 11 continues supplying DC power to the first power storing means 15. While the rectifier 11 is stopping supplying DC power to the first power storing means 15, the vehicle 50 is charged with DC power from only the first power storing means 15.

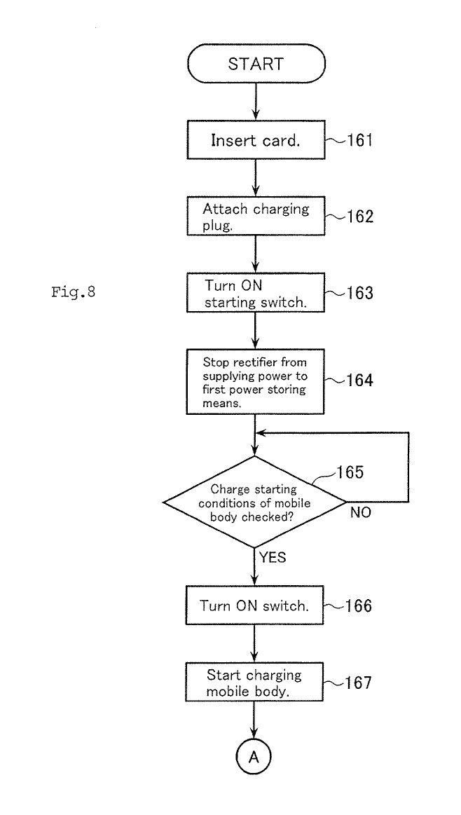

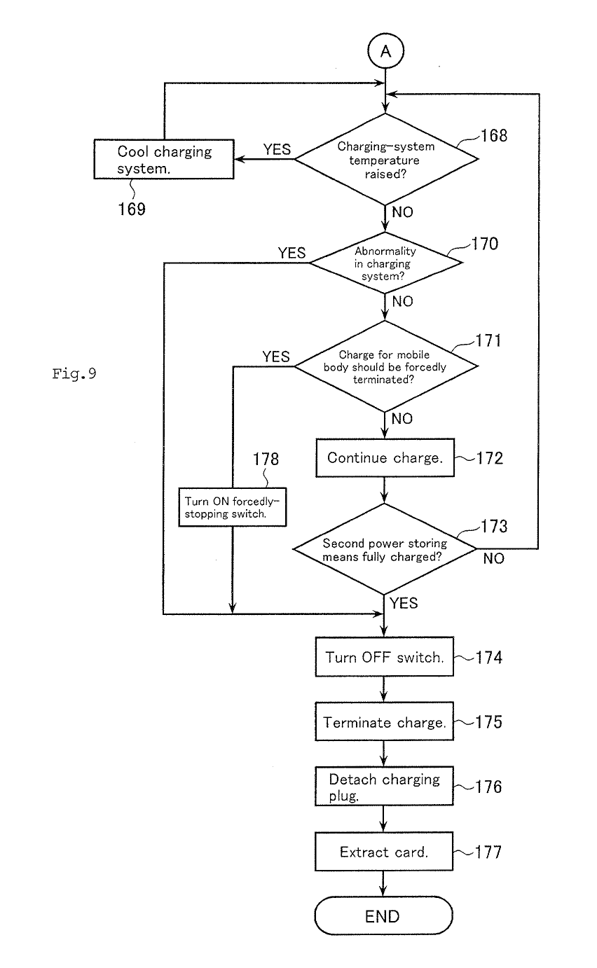

FIGS. 8 and 9 show an operation procedure from the start to the end of a charge in the boosting charge method for an electrically-driven mobile body. The vehicle 50 arrives at a charging station and stops near a vacant charging stand 21, and before charged, a driving switch (not shown) of the vehicle 50 is turned off and a parking brake (not shown) is put in operation to thereby anchor the vehicle 50 in place. Thereafter, as given in a step 161, a charge card (not shown) equivalent to cash for charging the vehicle 50 is inserted into the card reader 23 of the charging stand 21. Next, in a step 162, the charging cable 35 held on the charging stand 21 is removed and the charging plug 36 at the front end of the charging cable 35 is pushed and attached into the charging connector 65 of the vehicle 50. The charging plug 36 is completely attached thereto to thereby connect the charging circuit 20 to the vehicle 50. On the side of the vehicle 50, the lock sensor 71 checks that the charging plug 36 is attached.

Upon attaching the charging plug 36, the processing goes to a step 163 in which the charge starting switch 24 of the charging stand 21 is turned on. Sequentially, the rectifier 11 stops supplying electric power to the first power storing means 15 in a step 164, and in this state, the rectifier 11 and the first power storing means 15 are electrically cut off, thereby enabling only the first power storing means 15 to supply and charge the vehicle 50 with electric power. After the power supply to the first power storing means 15 makes a stop, the processing goes to a step 165 in which a decision is made whether charge starting conditions of the vehicle 50 are all checked. Specifically, in the step 165, a decision is made whether the signal S11 from each lock sensor 71, the signal S12 from the voltage measurement sensor 33, the signal S13 from the driving-start checking sensor 72 and the signal S14 from the parking-brake sensor 73 have been inputted. If the decision is made at the step 165 that the charge starting conditions have been checked, then the switch 31 for the charging circuit 20 is turned on in the step 166 to thereby start charging the vehicle 50 in the step 167.

Next, upon starting to charge the vehicle 50, the processing goes to a step 168 in which a decision is made whether the temperature of the charging system has risen. If the decision is made at the step 168 that the temperature has exceeded the predetermined value, then in a step 169, the cooling means 60 cools the power control section 81 and the second power storing means 85. On the other hand, if deciding at the step 169 that the temperature of the charging system is normal, a decision is made in a step 170 whether there is an abnormality in the charge control function or the like of the charging system. If the decision is made at the step 170 that there is an abnormality in the charge control function or the like, then in a step 174, the switch 31 is turned off to thereby stop the charge. On the other hand, if the decision is made at the step 170 that there is no abnormality in the charge control function or the like, then the processing goes to a step 171. In order to forcedly terminate the charge for the vehicle 50 in the step 171, the processing moves to a step 178 in which the charge forcedly-stopping switch 25 is turned on. If the charge forcedly-stopping switch 25 is turned on, then in a step 174, the switch 31 is turned off to thereby stop the charge. Terminating the charge forcedly is effective in giving the charge within a limited time range or in another such case, and a charge stopping timing can be selected by referring to a charging current indicated in the display section 26 of the charging stand 21. In this embodiment, the cooling means 60 comes into operation after detecting a rise in the temperature of the charging system. However, when the charging system cannot be cooled enough only through spontaneous heat dissipation, the cooling means 60 may be operated at the same time that the charge starts.

In the step 171, if there is no need to finish charging the vehicle 50, the charge continues in a step 172. In a step 173, a decision is made based on a charging-current measurement value in the second power storing means 85 whether the second power storing means 85 has been fully charged. In other words, the charge-information processing section 84 decides based on the signal S16 from the current sensor 76 whether the second power storing means 85 has been fully charged. At the step 173, if deciding that the second power storing means 85 has been fully charged, then in the step 174, the switch 31 is turned off to thereby terminate the charge (step 175) . Sequentially, the charging plug 36 is detached from the charging connector 65 of the vehicle 50 (step 176), and after charged, a charge power amount and a charge power rate are indicated in the display section 26 of the charging stand 21. Thereafter, in a step 177, the charge power rate and the like are electrically written in the charge card (not shown) inserted into the charge card reader 23 of the charging stand 21 and paid on-line to a bank or the like, and then, the charge card is discharged from the charge card reader.

As described so far, a great amount of electric power stored in the first power storing means 15 can be directly utilized for charging the second power storing means 85, thereby charging the vehicle 50 in a short time. Specifically, the first power storing means 15 is capable of storing electric power, for example, hundreds times as great as that of the second power storing means 85 of the vehicle 50, sending the great amount of electric power stored therein directly to the vehicle 50 because a charge control function or the like does not lie between the first power storing means 15 and the vehicle 50, and thereby, as shown in FIG. 4, giving a boosting charge simultaneously to a plurality of vehicles.

According to the present invention, the vehicle 50 houses the charge controlling means 80 and thereby controls pure DC power supplied from the first power storing means 15 in such a way that the pure DC power has a charging voltage and a charging current most suitable for charging the second power storing means 85. In other words, since the function of the charge controlling means 80 significantly affects the life or the like of the second power storing means 85, the charge controlling means 80 is mounted on the vehicle 50, thereby working out a design in such a way that the charging characteristics of the second power storing means 85 are matched to the charge control function. This enables the second power storing means 85 to have as high a performance as expected, thereby enhancing the performance of the vehicle 50. Besides, the vehicle 50 is supplied with high-quality electric power such as pure DC power, and taking this into account, an electric control circuit of the vehicle 50 can be designed. Accordingly, there is little need to consider a ripple, a noise or a surge in DC power supplied to the vehicle 50 given a boosting charge, thereby facilitating a design for an electric control circuit of the vehicle 50 and making the electric control function of the vehicle 50 more reliable.

Although the charging procedure for only the vehicle 50 is described above, as shown in FIG. 4, if the plurality of vehicles are simultaneously charged, then each vehicle is fully charged in a mutually different time because the second power storing means 85, 85a, 85b and 85c thereof each have a different capacity. Upon starting a charge, the charging current of the vehicle 50, the sports car 51, the bus 52 and the truck 53 become I1, I2, I3 and I4, respectively. Then, each vehicle is continuously charged and thereby the charging current becomes far less than when the charge starts and nearly null as fully charged. When the second power storing means 85a, 85b and 85c have been fully charged, each switching means 30 outputs the power-supply stop signal S7 to the power-supply controlling means 12 to thereby automatically stop the charge for each vehicle.

In this embodiment, the cooling means 60 is used for cooling the charging system, but the electronic cooling element 61 has a cooling surface as well as a heat-generation surface and thereby has the function of regulating the temperature of the vehicle 50, so that the cooling means 60 not only can cool the charging system, but also can be used as an air conditioner for the vehicle 50. Hence, the cooling means 60 provided with the electronic cooling element 61 is used as the air conditioner, thereby saving a CFC or the like as a refrigerant for a conventional air conditioner to contribute toward improving the global environment.

Although the first power storing means 15 is fixed in a specified position in this embodiment, a truck or the like can be loaded with the first power storing means 15 and used as an auxiliary charging vehicle. Specifically, the charge controlling means 80 mounted on the vehicle 50 has the function of giving an optimum charge to the second power storing means 85, thereby saving providing the truck with a control unit for charging the vehicle 50 and giving a boosting charge easily to the second power storing means 85 of the vehicle 50 using the first power storing means 15 loaded on the truck in a location where no boosting-charge station is laid even if the residual capacity of the second power storing means 85 decreases significantly after long-distance traveling. Hence, the variety of vehicles 50, 51, 52 and 53 of FIG. 4 can be given a boosting charge with DC power from the single first power storing means 15 on the truck.

### SECOND EMBODIMENT

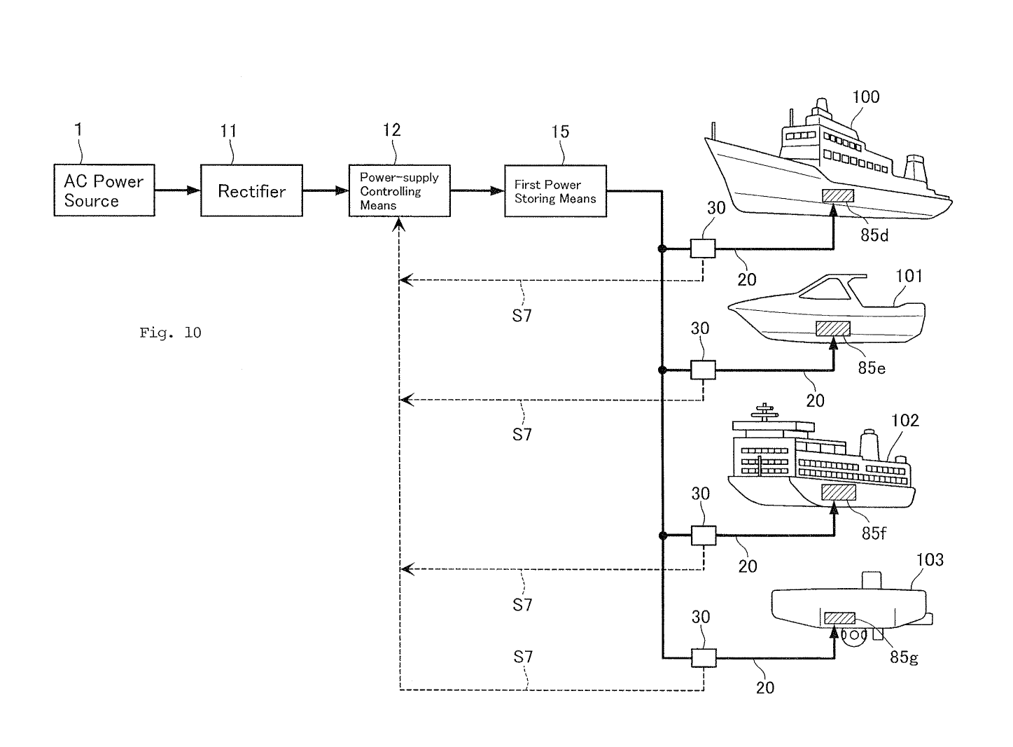

FIG. 10 shows a second embodiment of the present invention which is applied to a boosting charge for a ship as an electrically-driven mobile body. As shown in FIG. 10, a second power storing means 85d of a passenger ship 100, a second power storing means 85e of a motorboat 101, a second power storing means 85f of a car ferry 102 and a second power storing means 85g of a bathyscaphe 103 can be supplied with electric power for charge through each charging circuit 20 connected in parallel to the first power storing means 15. In view of improvements in the global environment, more ships propelled by electric power should desirably be used. As a prime mover for shipping, for example, a high-temperature super conducting motor having a high performance may desirably be employed. In this implementation, the pure DC power supplied from the first power storing means 15 is controlled to charge each ship, and thereby, the charging voltage and charging current for each second power storing means 85d, 85e, 85f and 85g are most suitably controlled. This makes it possible to give a boosting charge simultaneously to various ships.

### THIRD EMBODIMENT

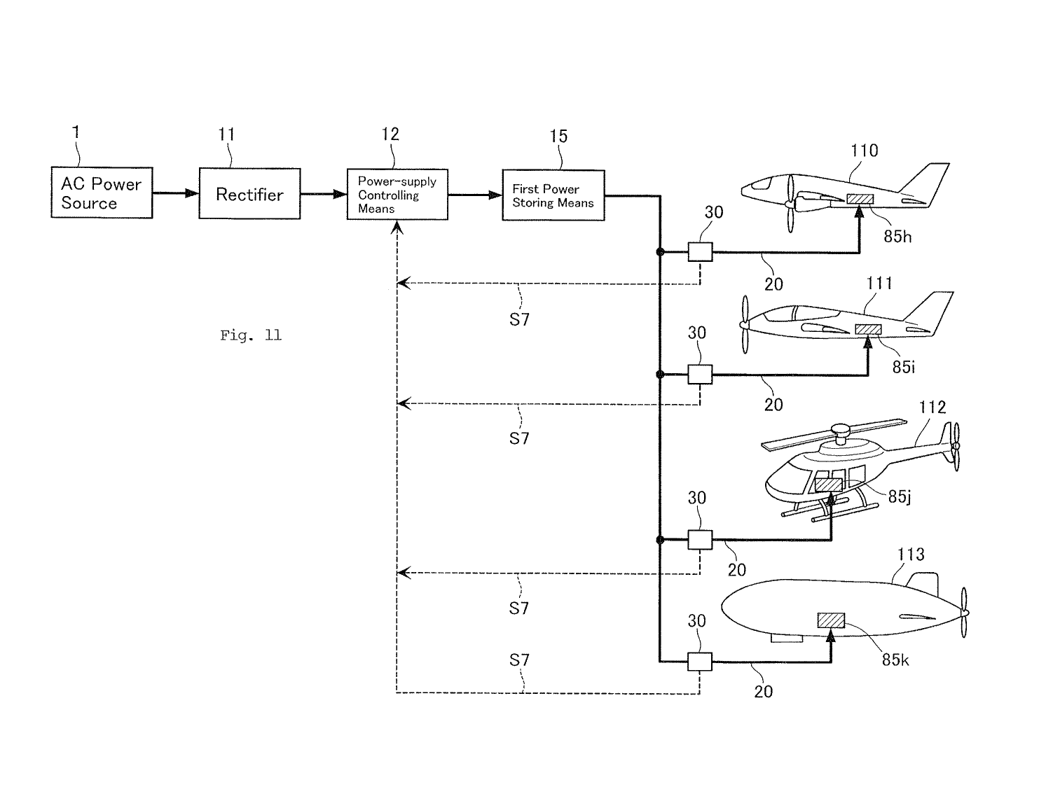

FIG. 11 shows a third embodiment of the present invention which is applied to a boosting charge for an aircraft as an electrically-driven mobile body. As shown in FIG. 11, a second power storing means 85h of a twin-engine aircraft (including a vertical take-off and landing (VTOL) aircraft) 110, a second power storing means 85i of a single-engine aircraft 111, a second power storing means 85j of a helicopter 112 and a second power storing means 85k of an airship 113 can be supplied with electric power for charge through each charging circuit 20 connected in parallel to the first power storing means 15. In view of improvements in the global environment, more aircraft propelled by electric power should desirably be used. It is desirable that an aircraft has a prime mover such as a light core-less motor. Each aircraft makes a flight by rotating a propeller or a rotor blade with electric power from the first power storing means 15. In this implementation, the pure DC power supplied from the first power storing means 15 is controlled to charge each aircraft, and thereby, the charging voltage and charging current for each second power storing means 85h, 85i, 85j and 85k are most suitably controlled. This makes it possible to give a boosting charge simultaneously to various aircraft. If an aircraft is difficult to mount a large amount of the large-capacity second power storing means 85h, 85i 85j, 85k on, taking the body weight thereof into account, then a fuel battery may be employed together with the second power storing means 85h, 85i, 85j, 85k.

### FOURTH EMBODIMENT

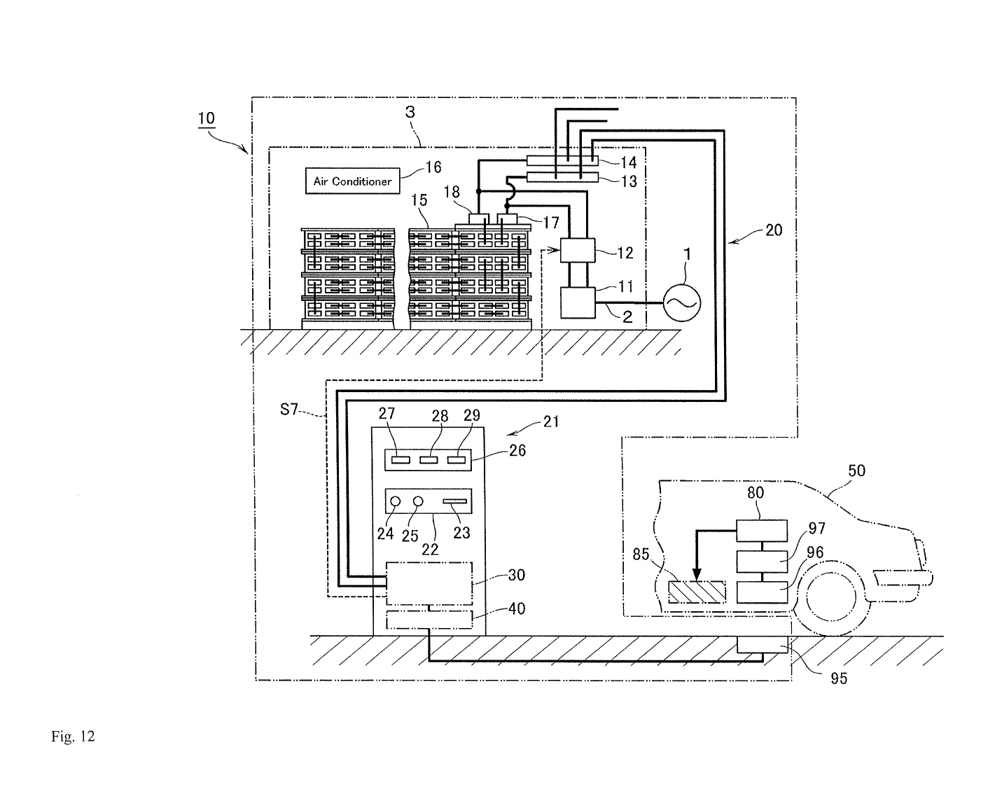

FIG. 12 shows a fourth embodiment of the present invention which is a variation of the first embodiment. Herein, component elements are given the same reference characters and numerals as those of the first embodiment, as long as the former are identical to the latter, and their description is omitted, which is also applied to the other embodiment described below.

In the first embodiment, electric power is supplied with the conductors being in contact in a conductive charging method while in the fourth embodiment, electric power is supplied with the conductors being out of contact using electro-magnetic induction in an inductive charging method, thereby facilitating the charging work. As shown in FIG. 12, the switching means 30 is provided with an inverter 40 converting a direct current into an alternating current and more specifically converting DC power from the first power storing means 15 into high-frequency AC power. The inverter 40 is connected on the output side to a primary winding 95 buried in the ground with only the upper surface exposed to the ground surface. The vehicle 50 is provided at the floor part thereof with a secondary winding 96 and stops right over the primary winding 95 for a boosting charge in such a way that the secondary winding 96 faces the primary winding 95. In the boosting charge, the inverter 40 supplies the primary winding 95 with high-frequency power, the secondary winding 96 generates AC power induced through electro-magnetic induction, a converter 97 converts the AC power generated in the secondary winding 96 into DC power, and the charge controlling means 80 is supplied with the DC power.

In the thus configured fourth embodiment, electric power from the first power storing means 15 is supplied with the conductors staying out of contact to the charge controlling means 80 of the vehicle 50, thereby enabling a boosting charge without the charging plug 36 of FIG. 5. This needs no mechanical connection for a boosting charge, thereby facilitating the boosting-charge work significantly.

### FIFTH EMBODIMENT

FIG. 12 shows a fifth embodiment of the present invention which is a variation of the first embodiment. A wind power generator 5 or a solar-photovoltaic power generator 6 is a power generator which consumes no fossil fuel, emits no carbon dioxide and thereby is environment-friendly. In the wind power generator 5 or the solar-photovoltaic power generator 6, however, the output varies significantly according to the weather, thereby causing the problem of making harder in collaborating with an electric power system. The fifth embodiment is capable of storing electric power from the wind power generator 5 or the solar-photovoltaic power generator 6 subjected to significant output variations in the first power storing means 15 and giving the vehicle 50 a boosting charge with the electric power in storage.

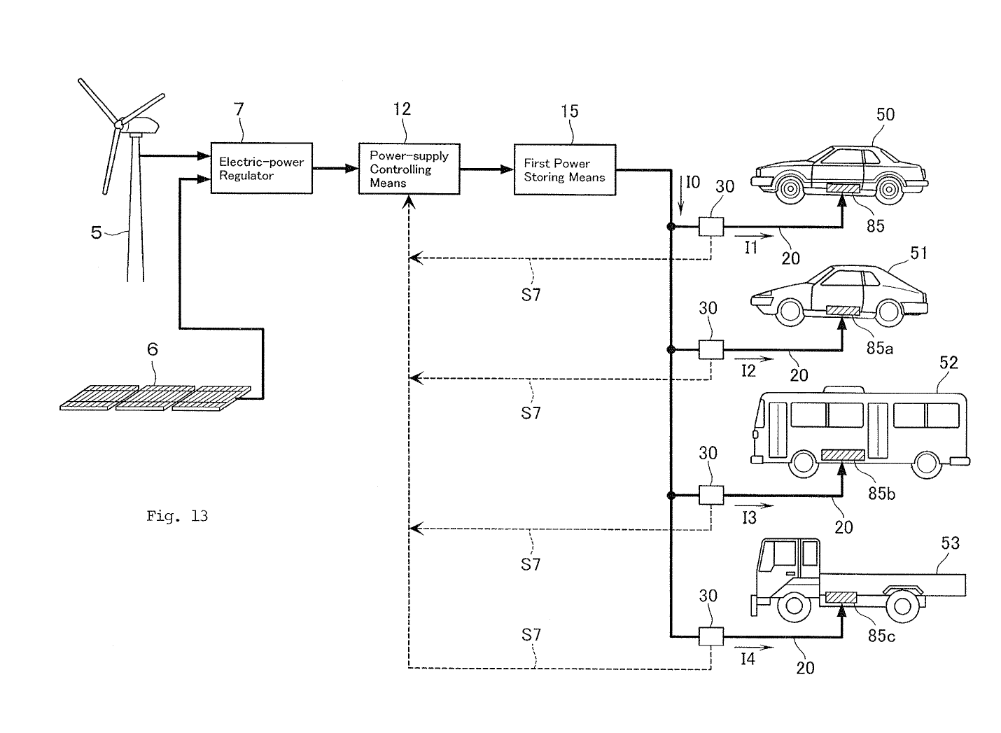

As shown in FIG. 13, the power-supply controlling means 12 is provided on the input side with an electric-power regulator 7. The electric-power regulator 7 regulates electric power from the wind power generator 5 or the solar-photovoltaic power generator 6 in such a way that it becomes DC power for entering the first power storing means 15 to thereby supply the DC power to the first power storing means 15 via the power-supply controlling means 12. As the first power storing means 15, desirably, a most suitable type may be selected for significant power variations. The first power storing means 15 may be supplied with electric power from the wind power generator 5 alone or from the solar-photovoltaic power generator 6 alone, or from both.

According to the thus configured fifth embodiment, the first power storing means 15 can store electric power from the wind power generator 5 or the solar-photovoltaic power generator 6 subjected to significant output variations, thereby giving each type of vehicle 50, 51, 52, 53 a boosting charge with the electric power in storage. Conventionally, in order to make wind power generation or solar-photovoltaic power generation more available, electric power from the wind power generator 5 or the solar-photovoltaic power generator 6 subjected to significant output variations is stored in an electric-power storage battery to thereby level the output power in such a way that it collaborates with an electric power system. However, the electric-power storage battery provided only for the leveling raises power-generation costs and thereby hinders utilizing renewable energy actively. In the fifth embodiment, therefore, electric power from the wind power generator 5 or the solar-photovoltaic power generator 6 is stored in the first power storing means 15 and used forgiving a boosting charge to each type of vehicle 50, 51, 52, 53, thereby compensating for the disadvantage in that power generation with renewable energy undergoes significant output variations and hence promoting the use of renewable energy such as sunlight and wind force.

Hereinbefore, the first to fifth embodiments of the present invention are described in detail. However, concrete configurations thereof are not limited to these embodiments. Therefore, unless changes and modifications in design depart from the scope of the present invention, they should be construed as being included therein. For example, the electrically-driven mobile body subjected to a boosting charge is a so-called transportation machine including a vehicle, a ship and an aircraft. It is not limited to a long-distance mobile body and also includes a construction machine, an industrial machine and the like which move only within a limited range. Further, as described in the first embodiment, pure DC power may desirably be used as DC power supplied to the vehicle 50 as an electrically-driven mobile body by the power supply apparatus 10, but as a matter of course, the DC power supplied to the vehicle 50 may be DC power having a ripple outputted from a rectifier.

### (FIG. 1)

### 15 . . . First Power Storing Means

### 22 . . . Operation Section

### 26 . . . Display Section

### 30 . . . Switching Means

### 80 . . . Charge Controlling Means

### 85 . . . Second Power Storing Means

### (FIG. 2)

### 15 . . . First Power Storing Means

### 30 . . . Switching Means

### 81 . . . Power Control Section

### 84 . . . Charge-information Processing Section

### 85 . . . Second Power Storing Means

(FIG. 3: Refer to FIG. 2 except the following.)

### 83 . . . Temperature Control Unit

### (FIGS. 4, 10 and 11)

### 1 . . . AC Power Source

### 11 . . . Rectifier

### 12 . . . Power-supply Controlling Means

### 15 . . . First Power Storing Means

### (FIGS. 5 and 12)

### 16 . . . Air Conditioner

### (FIG. 6)

### 12 . . . Power-supply Controlling Means

### 15 . . . First Power Storing Means

### 31 . . . Switch

### 32 . . . Switching Control Section

### 80 . . . Charge Controlling Means

### (FIG. 7)

### START

151 . . . Charge request made by mobile body?
152 . . . Stop supplying power to first power storing means.
153 . . . Continue supplying power to first power storing means.

### (FIG. 8)

### START

161 . . . Insert card.
162 . . . Attach charging plug.
163 . . . Turn ON starting switch.
164 . . . Stop rectifier from supplying power to first power storing means.
165 . . . Charge starting conditions of mobile body checked?
166 . . . Turn ON switch.
167 . . . Start charging mobile body.

### (FIG. 9)

168 . . . Charging-system temperature raised?
169 . . . Cool charging system.
170 . . . Abnormality in charging system?
171 . . . Charge for mobile body should be forcedly terminated?
172 . . . Continue charge.
173 . . . Second power storing means fully charged?
174 . . . Turn OFF switch.
175 . . . Terminate charge.
176 . . . Detach charging plug.
177 . . . Extract card.
178 . . . Turn ON forcedly-stopping switch.

### END

### (FIG. 13)

### . . . Electric-power Regulator

### . . . Power-supply Controlling Means

. . . First Power Storing Means

1. An electrically-driven mobile body which includes a power storing means storing electric power supplied by an external power supply apparatus and is driven with electric power stored in the power storing means, comprising:
a charge controlling means for controlling DC power sent directly from the external power supply apparatus in such a way that the DC power has a voltage and an electric current suitable for giving the power storing means a boosting charge; and
a cooling means for cooling a charging system of the power storing means forcedly with DC power sent directly from the external power supply apparatus.

2. The electrically-driven mobile body according to claim 1, wherein the cooling means includes an electronic cooling element operating with DC power from the external power supply apparatus.

3. The electrically-driven mobile body according to claim 1, wherein the charge controlling means includes a charge control unit having a DC chopper circuit for regulating DC power supplied by the power supply apparatus in such a way that the DC power has a voltage suitable for giving a boosting charge to the power storing means.

4. The electrically-driven mobile body according to claim 1, wherein the power storing means is formed by at least one of a storage battery, an electric double-layer capacitor and a lithium-ion capacitor.

5. The electrically-driven mobile body according to claim 1, wherein the power storing means is formed by a lithium-ion battery.

6. The electrically-driven mobile body according to claim 1, wherein the charge controlling means is provided with a charge-completion alarming means notifying a portable receiver of the driver that a charge given to the power storing means is completed.

7. A boosting charge method for an electrically-driven mobile body which stores, in a second power storing means provided therein, electric power supplied by an external power supply apparatus provided with a first power storing means and is driven with electric power stored in the second power storing means, comprising the steps of:
controlling DC power sent directly from the first power storing means of the external power supply apparatus in such a way that the DC power has a voltage and an electric current suitable for giving the second power storing means a boosting charge; and
cooling a charging system of the second power storing means forcedly with DC power sent directly from the first power storing means of the external power supply apparatus.

8. The boosting charge method for an electrically-driven mobile body according to claim 7, wherein the electrically-driven mobile body is supplied with pure DC power from the first power storing means of the power supply apparatus.

9. The boosting charge method for an electrically-driven mobile body according to claim 7, wherein the electrically-driven mobile body is supplied with DC power from the power supply apparatus by either a conductive charging method or an inductive charging method.

10. The boosting charge method for an electrically-driven mobile body according to claim 7, wherein the electrically-driven mobile body is supplied with DC power generated using renewable energy.
